(19) United States
(12) Patent Application Publication
(10) Pub. No.: US 2006/0162297 A1
(43) Pub. Date: Jul. 27, 2006

(54) Method for the post-treatment of exhaust gases and device therefor

(76) Inventor: Patrik Hartherz, Ludwigsburg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/526,309

(22) PCT Filed: Jun. 16, 2003
(86) PCT No.: PCT/DE03/02001

§ 371 Date: Mar. 2, 2005

(30) Foreign Application Priority Data
Sep. 5, 2002 (DE) 102 41 063.1

(51) Int. Cl. B01D 46/00

(52) U.S. Cl. 55/282.3

(57) ABSTRACT

A method and an apparatus for posttreatment of the exhaust gas of an internal combustion engine in which particles contained in the exhaust gas are at least partly eliminated with the at least intermittent use of an oxidatively acting aid, and in a further step, an at least partial removal of nitric oxides from the exhaust gas is effected, and the oxidatively acting means is delivered to the exhaust gas in metered fashion in such a way that the removal of nitric oxides from the exhaust gas is reinforced.

### PRIOR ART

The invention is based on a method and an apparatus as generically defined by the preambles to the independent claims. From German Patent Disclosure DE 199 04 068 A1, a method is already known in which ozone is discharged to the exhaust gas at a discharge point in the exhaust-gas line before the exhaust gas reaches the particle filter. It is also known to provide an oxidative catalytic converter upstream of a particle filter or a storage-type catalytic converter, in order to reinforce burnoff of soot or the removal of nitric oxides from the exhaust gas by increasing the proportion of nitrogen dioxide in the exhaust gas. However, an oxidative catalytic converter has the disadvantage of a low conversion rate in converting nitrogen monoxide into nitrogen dioxide at exhaust gas temperatures below 250° C. Moreover, an oxidative catalytic converter is vulnerable to sulfur and from sulfur dioxide produces sulfur trioxide, which can poison a storage-type catalytic converter. Furthermore, with an oxidative catalytic converter, quantity-oriented control of the conversion of nitrogen monoxide into nitrogen dioxide cannot be done.

### ADVANTAGES OF THE INVENTION

The method of the invention and the apparatus of the invention having the definitive characteristics of the independent claims have the advantage over the prior art, with an oxidatively acting aid, of enabling both efficient particle elimination and efficient removal of nitric oxides from the exhaust gas; the oxidatively acting aid also assures sulfur-tolerant oxidation of the nitrogen monoxide present in the exhaust gas in the low-temperature range. Furthermore, by means of the oxidatively acting aid, an adjustment as needed of a defined quantity relationship of nitrogen monoxide to nitrogen dioxide in the exhaust gas can be done as a function of the temperature, such as the ratio 1:1 at temperatures below 250° C. in the case of removal of nitric oxides from exhaust gas by the method of selective catalytic reduction. The nitrogen dioxide produced is a direct function of the oxidative aid employed and can be regulated by way of a defined generation of the oxidative aid, in particular ozone.

By the provisions recited in the dependent claims, advantageous refinements of and improvements to the method and apparatus recited in the independent claims are possible.

It is especially advantageous in this respect that the oxidatively acting means is generated outside the exhaust-gas stream, so that no additional exhaust gas counterpressure is generated in the exhaust system, and the generating means can be embodied relatively simply and economically.

Further advantages result from the characteristics recited in the further dependent claims and in the specification.

### DRAWING

Exemplary embodiments of the invention are shown in the drawing and explain in further detail in the ensuing description.

FIG. 1 shows an exhaust-gas cleaning device with a particle filter and a nitric oxide removal device.

### DESCRIPTION OF THE EXEMPLARY EMBODIMENTS

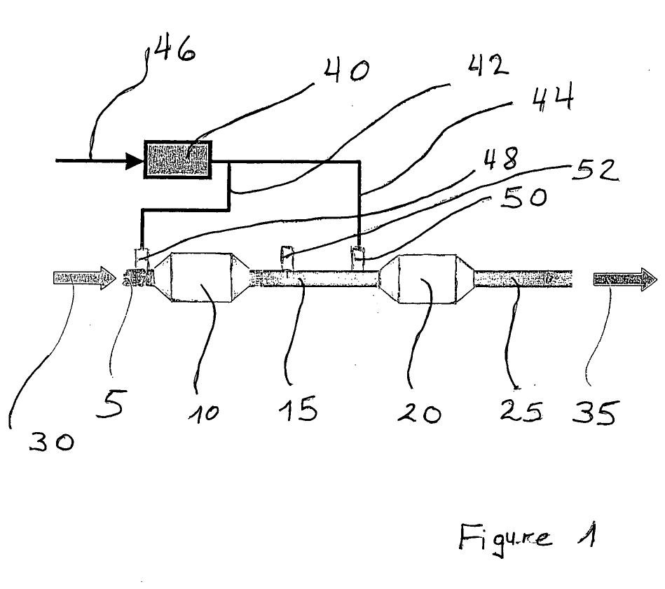

In FIG. 1, an exhaust-gas cleaning device is shown, in which exhaust gas 30 arriving from an internal combustion engine can flow into a Diesel particle filter 10 via an exhaust-gas line 5. A further exhaust-gas line 15 connects the outlet of the particle filter 10 to a nitric oxide removal device 20, embodied as an NOx storage-type catalytic converter. The output of the nitric oxide removal device 20 is connected to a further exhaust-gas line 25, which carries the cleaned exhaust gas 35 onward into the open air via a muffler. A plasma generator for ozone generation is also provided as a means 40 for furnishing an oxidatively following aid. The ozone generator has an air inlet 46. The outlet of the ozone generator communicates with both a first ozone line 42 and a second ozone line 44. A first delivery device 48 and a second delivery device 50 are located on the other end of the further ozone lines 42 and 44, respectively, and protrude into the exhaust-gas line 5 and the exhaust-gas line 15, respectively. A nitrogen dioxide measuring element 52 is also provided in the region of the exhaust-gas line 15, and a temperature measuring element for measuring the temperature of the exhaust gas is integrated with it.

The exhaust gas 30 flowing from the engine contains nitrogen monoxide, hydrocarbons, water, and soot particles. Via the delivery device 48, ozone is delivered to the exhaust gas 30 upstream of the particle filter 10. As a result, a certain proportion of the nitrogen monoxide component in the exhaust gas is oxidized into nitrogen dioxide, and as a result, a continuous burnoff of soot is assured in the particle filter 10 by utilizing the CRT effect known per se (CRT stands for Continuously Regenerating Technology, or Continuously Regenerating Trap; see also http://www.dieselnet.com/tech/dpf_crt.html). The ozone delivery is done here as a function of the measured exhaust gas temperature, for optimizing the regeneration of the particle filter. Generating the ozone outside the exhaust system has the advantage that no additional exhaust gas counterpressure is generated; that the reactor for generating the ozone cannot become plugged with soot; and that this reactor is not exposed to any high temperatures, either, so that only little technological effort and expense are required to furnish an apparatus that is functional for the present purposes. Downstream of the particle filter 10, that is, in the region of the exhaust-gas line 15, the soot particles are for the most part removed, but the proportion of nitrogen monoxide is increased somewhat in comparison with the exhaust gas in the inlet region of the Diesel particle filter, or in other words after the delivery of the ozone through the first delivery device 48. The nitrogen dioxide measuring element 52 records the actual proportion of nitrogen dioxide and enables a control unit, not further shown, to trigger the ozone generator 40 and the delivery devices 48 and 50 accordingly, in order to assure proper function of the downstream storage-type catalytic converter 20. It is assured in particular by the delivery of ozone via the delivery device 50 that the exhaust gas on entering the storage-type catalytic converter will have the highest possible proportion of nitrogen dioxide, which is trapped well by the storage-type catalytic converter and can thus effectively be reduced to nitrogen. Via the exhaust-gas line 25, the cleaned exhaust gas 35 leaves the arrangement shown, and at that point it essentially now contains only nitrogen and water.

In an alternative embodiment, an oxidative catalytic converter can also be connected downstream of the storage-type catalytic converter, in order to oxidize hydrocarbons that still remain in the exhaust gas. In a further alternative embodiment, the two delivery devices 48 and 50, instead of comprising a valve, in particular an electrically triggerable valve, may comprise a nozzle or only the line end of the lines 42 and 44. In that case, the control of the ozone delivery is effected by an electrical triggering of the ozone generator 40. In a further alternative, a second delivery point can be dispensed with entirely; that is, the second ozone line 44 and the second delivery device 50 can be omitted, and the ozone can be delivered to the exhaust system solely via the ozone line 42. This is possible particularly in the case of an alternative embodiment of the nitric oxide removal device as a device that is based on the method of selective catalytic reduction (see also http://www.dieselnet.com/tech/cat_scr.html). Regulating the ozone delivery is then effected solely via the metering point in the region of the exhaust-gas line 5 upstream of the particle filter 10, by delivering enough ozone at this point that downstream of the Diesel particle filter, enough nitrogen dioxide still remains to assure proper function of the nitric oxide removal device. The particle filter 10 can selectively also be embodied as catalytically coated. As an alternative to, or in combination with, an ongoing regeneration of the particle filter, it may also be provided that the ozone delivery be controlled such that the particle filter 10 is regenerated only in an emergency, while the removal of nitric oxides from the exhaust gas proceeds continuously. To that end, the ozone is then preferably delivered via the second delivery device 50, and only in the event of an emergency regeneration of the particle filter 10 is the delivery device 52 activated. The emergency regeneration is activated whenever the exhaust gas counterpressure exceeds a certain limit value. To detect such a threshold value, a precondition in this case is the provision of at least one pressure measuring element, or alternatively, two pressure sensors are used, in order to ascertain the exhaust gas counterpressure by way of a differential pressure determination. In still another alternative embodiment, other oxidation means may be employed besides ozone. Instead of being delivered or blown into the exhaust system, the oxidative aids may also be generated in the exhaust system, for instance using a plasma generator through which the exhaust gas can flow.

1-11. (canceled)

12. In a method for posttreatment of the exhaust gas of an internal combustion engine, in which particles contained in the exhaust gas are at least partly eliminated with the at least intermittent use of an oxidatively acting aid, the improvement comprising the steps of effecting an at least partial removal of nitric oxides from the exhaust gas, and delivering the oxidatively aid means to the exhaust gas in metered fashion in such a way that the removal of nitric oxides from the exhaust gas is reinforced.

13. The method of claim 12, further comprising the steps of determining the proportion of nitrogen dioxide in the exhaust gas, and delivering the oxidatively acting aid as a function of the proportion of nitrogen dioxide.

14. The method of claim 13, wherein the proportion of nitrogen dioxide is determined downstream, in terms of the flow direction of the exhaust gas, of the point where the particle elimination is effected.

15. The method of claim 12, further comprising the steps of measuring the temperature of the exhaust gas and effecting the metering of the oxidatively acting aid as a function of the temperature of the exhaust gas.

16. The method of claim 13, further comprising the steps of measuring the temperature of the exhaust gas and effecting the metering of the oxidatively acting aid as a function of the temperature of the exhaust gas.

17. The method of claim 14, further comprising the steps of measuring the temperature of the exhaust gas and effecting the metering of the oxidatively acting aid as a function of the temperature of the exhaust gas.

18. The method of claim 12, further comprising the step of generating the oxidatively acting aid outside the exhaust-gas stream.

19. The method of claim 13, further comprising the step of generating the oxidatively acting aid outside the exhaust-gas stream.

20. The method of claim 14, further comprising the step of generating the oxidatively acting aid outside the exhaust-gas stream.

21. The method of claim 15, further comprising the step of generating the oxidatively acting aid outside the exhaust-gas stream.

22. The method of claim 18, wherein the generation of the oxidatively acting aid is effected in a metered fashion.

23. The method of claim 12, wherein the oxidatively acting aid is generated in a plasma generator.

24. The method of claim 13, wherein the oxidatively acting aid is generated in a plasma generator.

25. The method of claim 14, wherein the oxidatively acting aid is generated in a plasma generator.

26. The method of claim 12, wherein a particle filter is used for at least partial elimination of the particles and wherein the metering in of the oxidatively acting aid is effected upstream and downstream of the particle filter.

27. The method of claim 15, wherein a particle filter is used for at least partial elimination of the particles and wherein the metering in of the oxidatively acting aid is effected upstream and downstream of the particle filter.

28. The method of claim 12, further comprising the step of employing a storage-type catalytic converter or an apparatus for selective catalytic reduction for at least partial removal of nitric oxides from the exhaust gas.

29. The method of claim 26, further comprising the step of employing a storage-type catalytic converter or an apparatus for selective catalytic reduction for at least partial removal of nitric oxides from the exhaust gas.

30. The method of claim 12, wherein ozone is used as the oxidatively acting aid.

31. An apparatus for posttreatment of the exhaust gas of an internal combustion engine, the apparatus comprising
a particle filter
means for furnishing an oxidatively acting aid for operating the particle filter, and
a nitric oxide removal device (20) for at least partial removal of nitric oxides from the exhaust gas downstream of the particle filter (10) in terms of the flow direction of the exhaust gas.
